(19) United States
(12) Patent Application Publication
(10) Pub. No.: US 2016/0183562 A1
(43) Pub. Date: Jun. 30, 2016

(54) MINERAL LICK COMPOSITIONS FOR RUMINANTS AND METHODS OF MAKING AND USING THE SAME

(71) Applicant: BENEMILK OY, Raisio (FI)

(72) Inventors: Merja Birgitta HOLMA, Raisio (FI); Ilmo Pellervo ARONEN, Hinnerjoki (FI); Feng WAN, Issaquah, WA (US); Christopher John BUNTEL, Singapore (SG)

(73) Assignee: BENEMILK OY, Raisio (FI)

(21) Appl. No.: 14/909,108

(22) PCT Filed: Jul. 30, 2013
(86) PCT No.: PCT/US13/52629

§ 371 Date: Jan. 30, 2016

(51) Int. Cl. A23K 1/175

(52) U.S. Cl. CPC A23K 1/1751; A23K 1/1753; A23K 1/164; A23K 1/1813; A23K 1/1603; A23K 1/1634; A23K 1/004

(57) ABSTRACT

Mineral lick compositions for ruminants are disclosed, as well as methods for their preparation and use. The compositions may include at least one sodium salt, at least one calcium salt, at least one magnesium salt, and at least one fatty acid component comprising at least about 80% saturated fatty acid by weight.

### BACKGROUND

Increasing production and fat content of milk obtained from lactating ruminants has been a major goal for dairy farmers. Additional milk production per ruminant is beneficial because it results in a higher yield, thereby increasing profits. Increased milk fat is desirable because it has a higher economic value and can be used in highly desirable food products, such as cheese, yogurt, and the like.

A common approach to increasing either or both production and milk fat contents includes adjusting feed, nutrients, elements, vitamins, supplements, and/or the like provided to the ruminant. One such specific method includes feeding the ruminant a total mixed ration (TMR), which is a mix of grain and silage with some protein meals, such as, for example, soya bean meal and canola meal. Additional materials and trace elements, vitamins, extra nutrients, and the like may also be added to the TMR.

However, the current methods and feeds used to increase milk fat content tend to lower milk production, lower protein content, and/or have other detrimental effects on the ruminant. Furthermore, the methods and feeds oftentimes result in other undesired effects, such as increased trans fatty acid levels on the fatty acid profile of the milk fat.

### SUMMARY

In an embodiment, a mineral lick composition for ruminants may include at least one sodium salt, at least one calcium salt, at least one magnesium salt, and at least one fatty acid component comprising at least about 80% saturated fatty acid by weight.

In an embodiment, a method of preparing a mineral lick composition for ruminants may include combining at least one sodium salt, at least one calcium salt, at least one magnesium salt, and at least one saturated fatty acid component to provide a mineral lick mixture and forming the mineral lick composition from the mineral lick mixture.

In an embodiment, a method of increasing milk fat content in ruminants may include providing a mineral lick composition to a ruminant for ingestion. The mineral lick composition may include at least one sodium salt, at least one calcium salt, at least one magnesium salt, and at least one fatty acid component comprising at least about 80% saturated fatty acid by weight.

In an embodiment, a mineral lick composition for ruminants may include a fatty acid component including palmitic acid in an amount of at least about 60% by weight of the fatty acid component, at least one sodium salt, at least one calcium salt, and at least one magnesium salt. An unsaturated trans fatty acid content in the fatty acid component is in an amount of about 5% or less by weight of the fatty acid component.

### BRIEF DESCRIPTION OF THE DRAWINGS

FIG. 1 depicts a flow diagram of a method of preparing a mineral lick composition for ruminants according to an embodiment.

FIG. 2 depicts a flow diagram of an alternative method of preparing a mineral lick composition for ruminants according to various embodiments.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

A “ruminant” is a class of mammal with a multiple chamber stomach that gives the animal an ability to digest cellulose-based food by softening it within the first chamber (rumen) of the stomach and regurgitating the semi-digested mass. The regurgitate, known as cud, is then chewed again by the ruminant. Specific examples of ruminants include, but are not limited to, cattle, bison, buffaloes, yaks, camels, llamas, giraffes, deer, pronghorns, antelopes, sheep, and goats. The milk produced by ruminants is widely used in a variety of dairy-based products. Dairy cows are of considerable commercial significance for the production of milk and processed dairy products such as, for example, yogurt, cheese, whey, and ice cream.

“Silage” refers to a feed that includes chopped green forage, such as, for example, grass, legumes, and field corn. The silage is placed in a structure or a container that is designed to exclude air. The silage is then fermented in the structure or container, thereby retarding spoilage. Silage can have a water content of about 60% to about 80% by weight.

The present disclosure relates generally to dietary compositions such as supplements and the like that can be fed to ruminants for purposes of affecting milk production in the ruminant. Particularly, the dietary compositions described herein may be fed to a ruminant to increase the amount of milk produced by the ruminant and/or to increase the fat content of the milk produced by the ruminant, as described in greater detail herein. Specific compositions described herein may be in a mineral lick form.

When a ruminant consumes feed, the fat in the feed is modified by the rumen to provide a milk fat profile that is different from the profile of fat in the feed. All fats which are not completely inert in the rumen may decrease rumen digestibility of the feed material. Milk composition and fat quality can be influenced by the ruminant's diet. For example, oil feeding can have negative effects on both rumen function and milk formation. As a result of the oil feeding, the milk protein concentration is lowered, the fat concentration is decreased, and the proportion of trans fatty acids is increased. These have been connected especially to an increase in the harmful low-density lipoprotein (LDL) cholesterol and to a decrease in the beneficial high-density lipoprotein (HDL) cholesterol in human blood when the milk is consumed. In addition, the properties of the milk fat during industrial milk processing are weakened. A high level of polyunsaturated fatty acids in milk can also cause taste defects and preservation problems. A typical fatty acid composition of milk fat may contain more than 70% saturated fatty acids and total amount of trans fatty acids may vary in the range of 3%-10%. When vegetable oil is added into the feed, the proportion of trans fatty acids may rise to more than 10%.

One solution to diminishing the detrimental effect of oil and fat is to prevent triglyceride fat hydrolysis. Fat hydrolysis can be decreased, for example, by protecting fats with formaldehyde treated casein. Another alternative is to make insoluble fatty acid calcium salts whereby hydrogenation in rumen can be avoided. However, fatty acid salts have a pungent taste, which can limit their usability in feeds and can result in decreased feed intake. The salts may also impact the pelletizing process of the feed.

Accordingly, the mineral lick composition described herein allows for the transfer of palmitic acid from the feed via the digestive tract into the blood circulation of a ruminant. This improves the energy efficiency of milk production of the ruminant. When the utilization of energy becomes more efficient, the milk production increases and the concentrations of protein and fat in the milk rise. Especially, the mineral lick composition enhances fat synthesis in the mammary gland by bringing milk fat components to the cell and therefore the energy consuming synthesis in the mammary gland is not necessary. Thus, glucose can more efficiently be used for lactose production whereupon milk production increases. The milk protein content rises since there is no need to produce glucose from amino acids. Thus, the ruminant therefore does not lose weight at the beginning of the lactation period.

In the various embodiments described herein, the mineral lick compositions may include at least one sodium salt, at least one calcium salt, at least one magnesium salt, and at least one fatty acid component. The fatty acid component may be primarily saturated fatty acid (such as palmitic acid) and may contain little or no unsaturated trans fatty acid, as described in greater detail herein. The fatty acid component may be about 30% to about 80% by weight of the composition, the at least one sodium salt may be about 5% to about 15% by weight of the composition, the at least one calcium salt may be about 5% to about 25% by weight of the composition, and the at least one magnesium salt may be about 5% to about 15% by weight of the composition.

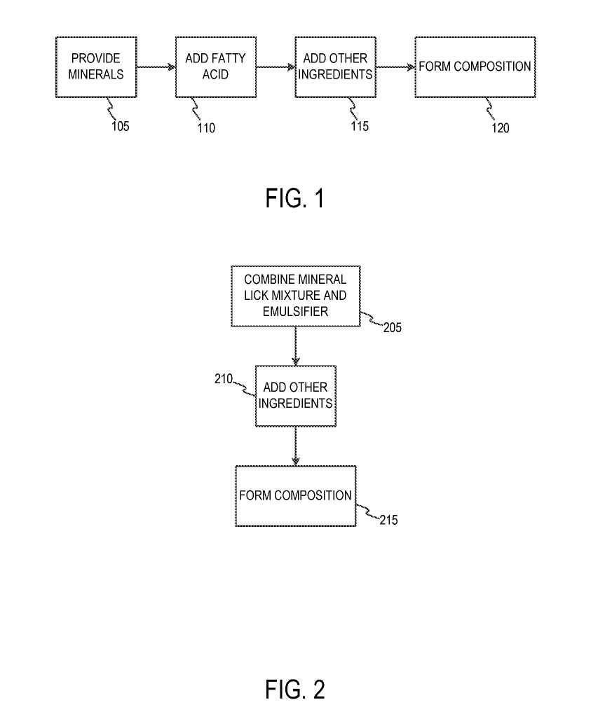

FIG. 1 depicts a flow diagram of a method of preparing a dietary composition for consumption by a ruminant. In various embodiments, the dietary composition may be formulated in a manner so that when consumed by the ruminant, the dietary composition maximizes particular qualities in the milk produced by the ruminant, as well as an amount of milk produced by the ruminant, as described in greater detail herein. In particular embodiments, the dietary composition may be a mineral lick composition, including, but not limited to, a solid, a non-liquid, an agglomeration, or a conglomeration. The terms “dietary composition” and “mineral lick composition” may be used interchangeably herein.

In various embodiments, the components described herein with respect to FIG. 1 may generally be combined in any order and/or any combination, and are not limited by the order described herein. In some embodiments, a mineral lick composition may be prepared by providing 105 a plurality of minerals and adding 110 a fatty acid to obtain a mineral lick mixture. Thus, processes 105 and 110 result in combining the plurality of minerals and the fatty acid to obtain the mineral lick mixture. The plurality of minerals, as described in greater detail herein, may include at least one sodium salt, at least one calcium salt, and at least one magnesium salt.

In various embodiments, the minerals described herein may be any mineral that is a generally recognized as safe (GRAS) mineral or a combination of such minerals. The mineral may further be obtained from any mineral source that provides a bioavailable mineral. The ratio of the at least one sodium salt to the at least one calcium salt to the at least one magnesium salt may be, for example, about 7:6:14.

The at least one sodium salt is not limited by this disclosure and may include any salt that contains at least one sodium ion. Illustrative examples of sodium salts include monosodium phosphate, sodium acetate, sodium chloride, sodium bicarbonate, disodium phosphate, sodium iodate, sodium iodide, sodium tripolyphosphate, sodium sulfate, sodium selenite, and/or the like. The sodium salt may be present in the mineral lick composition in an amount of about 5% by weight to about 15% by weight. Specific examples may include about 5% by weight, 7% by weight, 10% by weight, 10.7% by weight, 14% by weight, 15% by weight, or any range or value between any two of these values.

The at least one calcium salt is not limited by this disclosure and may include any salt that contains at least one calcium ion. Illustrative examples of calcium salts include calcium acetate, calcium carbonate, calcium chloride, calcium gluconate, calcium hydroxide, calcium iodate, calcium iodobehenate, calcium oxide, anhydrous calcium sulfate, calcium sulfate dehydrate, dicalcium phosphate, monocalcium phosphate, tricalcium phosphate, and/or the like. The calcium salt may be present in the mineral lick composition in an amount of about 5% by weight to about 25% by weight. Specific examples may include about 5% by weight, 7% by weight, 10% by weight, 12% by weight, 14% by weight, 15% by weight, 20% by weight, 21% by weight, 25% by weight, or any range or value between any two of these values.

The at least one magnesium salt is not limited by this disclosure and may include any salt that contains at least one magnesium ion. Illustrative examples of magnesium salts include magnesium acetate, magnesium carbonate, magnesium oxide, magnesium sulfate, and/or the like. The magnesium salt may be present in the mineral lick composition in an amount of about 5% by weight to about 15% by weight. Specific examples may include about 5% by weight, 5.6% by weight, 5.8% by weight, 7% by weight, 10% by weight, 14% by weight, 15% by weight, or any range or value between any two of these values.

The mineral lick mixture may additionally include one or more other minerals or any derivative thereof, such as, for example, potassium, phosphorus, zinc, sulfur, selenium, manganese, iron, cobalt, copper, iodine, molybdenum. Illustrative derivatives may include, for example, cobalt salts, manganese salts, potassium salts, iron salts, and zinc salts. Illustrative cobalt salts include cobalt acetate, cobalt carbonate, cobalt chloride, cobalt oxide, cobalt sulfate, and/or the like. Illustrative examples of manganese salts include manganese carbonate, manganese chloride, manganese citrate, manganese gluconate, manganese orthophosphate, manganese oxide, manganese phosphate, manganese sulfate, and/or the like. Illustrative examples of potassium salts include potassium acetate, potassium bicarbonate, potassium carbonate, potassium chloride, potassium iodate, potassium iodide, potassium sulfate, and/or the like. Illustrative examples of iron salts include iron ammonium citrate, iron carbonate, iron chloride, iron gluconate, iron oxide, iron phosphate, iron pyrophosphate, iron sulfate, reduced iron, and/or the like. Illustrative examples of zinc salts include zinc acetate, zinc carbonate, zinc chloride, zinc oxide, zinc sulfate, and/or the like. Other minerals may include, for example, copper sulfate, copper oxide, selenium yeast, and at least one chelated mineral. Chelated minerals may generally be a metallic mineral that has been solubilized by an amino acid. Illustrative chelated minerals may include magnesium aspartate and chromium picolinate.

In various embodiments, the fatty acid component may include one or more saturated fatty acid, unsaturated fatty acid, salts, or derivatives thereof. In various embodiments, the fatty acid component may generally include one or more free fatty acids and/or glycolipids. Free fatty acids may generally be unconjugated fatty acids, whereas glycolipids may be fatty acids conjugated with a carbohydrate. In some embodiments, the fatty acid component may be present in the mineral lick composition in an amount of about 30% by weight to about 80% by weight of the mineral lick composition. In particular embodiments, the fatty acid component may be present in the mineral lick composition in an amount of about 30% by weight, about 35% by weight, about 40% by weight, about 45% by weight, about 50% by weight, about 55% by weight, about 60% by weight, about 65% by weight, about 70% by weight, about 75% by weight, about 80% by weight, or any value or range between any two of these values. In some embodiments, the fatty acid component may represent about 30% to about 80% by weight of the mineral lick composition.

In some embodiments, the fatty acid component may have a melting point equal to or greater than about 40° C. In some embodiments, the fatty acid component may have a melting point of equal to or less than about 80° C. In some embodiments, the fatty acid component may have a melting point of about 40° C. to about 80° C. In particular embodiments, the fatty acid component may have a melting point of about 40° C., about 45° C., about 50° C., about 55° C., about 60° C., about 65° C., about 70° C., about 75° C., about 80° C., or any value or range between any two of these values.

In various embodiments, the fatty acid component may include at least one saturated fatty acid. For example, the fatty acid component may include 1, 2, 3, 4, 5, 6, or more different saturated fatty acids. In some embodiments, the saturated fatty acid may be present in the fatty acid component in an amount that results in a ruminant consuming the mineral lick composition to produce a desired quality and quantity of milk, as described in greater detail herein. Thus, in some embodiments, the saturated fatty acid may be present in an amount of about 90% by weight of the fatty acid component to about 100% by weight of the fatty acid component, including about 90% by weight, about 91% by weight, about 92% by weight, about 93% by weight, about 94% by weight, about 95% by weight, about 96% by weight, about 97% by weight, about 98% by weight, about 99% by weight, about 100% by weight, or any value or range between any two of these values. The saturated fatty acid is not limited by this disclosure, and may include any number of saturated fatty acids now known or later discovered, including all derivatives thereof. For example, derivatives of a saturated fatty acid may include salts, esters, amides, carbonates, carbamates, imides, anhydrides, alcohols, and/or the like.

As used herein, the term “salt” of the fatty acid may be any acid addition salt, including, but not limited to, halogenic acid salts such as, for example, hydrobromic, hydrochloric, hydrofluoric, and hydroiodic acid salt; an inorganic acid salt such as, for example, nitric, perchloric, sulfuric, and phosphoric acid salt; an organic acid salt such as, for example, sulfonic acid salts (methanesulfonic, trifluoromethane sulfonic, ethanesulfonic, benzenesulfonic, or p-toluenesulfonic), acetic, malic, fumaric, succinic, citric, benzoic, gluconic, lactic, mandelic, mucic, pamoic, pantothenic, oxalic, and maleic acid salts; and an amino acid salt such as aspartic or glutamic acid salt. The acid addition salt may be a mono- or di-acid addition salt, such as a di-hydrohalogenic, di-sulfuric, di-phosphoric, or di-organic acid salt. In all cases, the acid addition salt is used as an achiral reagent which is not selected on the basis of any expected or known preference for interaction with or precipitation of a specific optical isomer of the products of this disclosure.

The term “fatty acid ester” as used herein means an ester of a fatty acid. For example, the fatty acid ester may be in a form of RCOOR′. R may be any saturated or unsaturated alkyl group including, without limitation, C10, C12, C14, C16, C18, C20, and C24. R′ may be any group having from about 1 to about 1000 carbon atoms and with or without hetero atoms. In some embodiments, R′ may have from about 1 to about 20, from about 3 to about 10, and from about 5 to about 15 carbon atoms. The hetero atoms may include, without limitation, N, O, S, P, Se, halogen, Si, and B. For example, R′ may be a C₁₋₆alkyl, such as methyl, ethyl or t-butyl; a C₁₋₆alkoxyC₁₋₆alkyl; a heterocyclyl, such as tetrahydrofuranyl; a C₆₋₁₀aryloxyC₁₋₆alkyl, such as benzyloxymethyl (BOM); a silyl, such as trimethylsilyl, t-butyldimethylsilyl and t-butyldiphenylsilyl; a cinnamyl; an allyl; a C₁₋₆alkyl which is mono-, di- or trisubstituted by halogen, silyl, cyano or C₁₋₆aryl, wherein the aryl ring is unsubstituted or substituted by one, two or three, residues selected from the group consisting of C₁₋₇alkyl, C₁₋₇alkoxy, halogen, nitro, cyano and CF₃; or a C₁₋₂alkyl substituted by 9-fluorenyl.

As used herein, a “fatty acid amide” may generally include amides of fatty acids where the fatty acid is bonded to an amide group. For example, the fatty acid amide may have a formula of RCONR′R″. R may be any saturated or unsaturated alkyl group including, without limitation, C10, C12, C14, C16, C18, C20, and C24. R′ and R″ may be any group having from about 1 to about 1000 carbon atoms and with or without hetero atoms. In some embodiments, R′ may have from about 1 to about 20, from about 3 to about 10, and from about 5 to about 15 carbon atoms. The hetero atoms may include, without limitation, N, O, S, P, Se, halogen, Si, and B. For example, R′ and R″ each may be an alkyl, an alkenyl, an alkynyl, an aryl, an aralkyl, a cycloalkyl, a halogenated alkyl, or a heterocycloalkyl group.

A “fatty acid anhydride” may generally refer to a compound which results from the condensation of a fatty acid with a carboxylic acid. Illustrative examples of carboxylic acids that may be used to form a fatty acid anhydride include acetic acid, propionic acid, benzoic acid, and the like.

An “alcohol” of a fatty acid refers to a fatty acid having straight or branched, saturated, radical groups with 3-30 carbon atoms and one or more hydroxy groups. The alkyl portion of the alcohol component can be propyl, butyl, pentyl, hexyl, iso-propyl, iso-butyl, sec-butyl, tert-butyl, or the like. One of skill in the art may appreciate that other alcohol groups may also useful in the present disclosure.

In some embodiments, the saturated fatty acid may include a palmitic acid compound. The palmitic acid compound is not limited by this disclosure, and may include one or more of a conjugated palmitic acid, unconjugated palmitic acid, free palmitic acid, palmitic acid derivatives, and/or the like. Palmitic acid, also known as hexadecanoic acid, has a molecular formula of CH₃(CH₂)₁₄CO₂H. Specific examples of palmitic acid derivatives may include palmitic acid esters, palmitic acid amides, palmitic acid salts, palmitic acid carbonates, palmitic acid carbamates, palmitic acid imides, palmitic acid anhydrides, and/or the like. The palmitic acid compound may be present in the fatty acid component in an amount of about 60% by weight of the fatty acid to about 100% by weight of the fatty acid, including about 60% by weight, about 65% by weight, about 70% by weight, about 75% by weight, about 80% by weight, about 85% by weight, about 90% by weight, about 95% by weight, about 98% by weight, about 99% by weight, about 100% by weight, or any value or range between any two of these values. In some embodiments, the fatty acid component may consist essentially of the palmitic acid compound. In other embodiments, the fatty acid component may be entirely composed of the palmitic acid compound.

In some embodiments, the saturated fatty acid may include a stearic acid compound. The stearic acid compound is not limited by this disclosure, and may include conjugated stearic acid, unconjugated stearic acid, free stearic acid, stearic acid derivatives, and/or the like. Stearic acid, also known as octadecanoic acid, has a chemical formula of CH₃(CH₂)₁₆CO₂H. Specific examples of stearic acid derivatives may include one or more stearic acid esters, stearic acid amides, stearic acid salts, stearic acid carbonates, stearic acid carbamates, stearic acid imides, stearic acid anhydrides, and/or the like. Because stearic acid in large amounts may hinder milk production capacity of the mammary gland, the amount of stearic acid may be present in the fatty acid component in an amount of about 30% or less by weight of the fatty acid component. In particular embodiments, the stearic acid compound may include about 30% by weight of the fatty acid component, about 25% by weight of the fatty acid component, about 20% by weight of the fatty acid component, about 15% by weight of the fatty acid component, about 10% by weight of the fatty acid component, about 5% by weight of the fatty acid component, or any value or range between any two of these values.

In some embodiments, the fatty acid component may include an unsaturated fatty acid. The term “unsaturated fatty acid” as used herein refers to any mono- and polyunsaturated fat, and includes unsaturated trans fatty acids. The unsaturated fatty acids must contain at least one alkene linkage and may contain two or more alkene groups in any position in the hydrocarbon chain, and the unsaturation may or may not be present as a conjugated system of double bonds. The unsaturated fatty acid is not limited by this disclosure, and may include any number of unsaturated fatty acids now known or later discovered, including all derivatives thereof. For example, derivatives of an unsaturated fatty acid may include salts, esters, amides, anhydrides, alcohols, and/or the like, as previously described herein. In various embodiments, a minimal amount of unsaturated fatty acid in the fatty acid component to affect a desired quality of milk produced by the ruminant consuming the mineral lick composition may be used, as described in greater detail herein. Thus, in some embodiments, the fatty acid component may be substantially free of unsaturated fatty acids. As used herein with respect to unsaturated fatty acids, the term “substantially free” is understood to mean substantially no amount of unsaturated fatty acids or about 10% or less by weight of unsaturated fatty acids, including trace amounts of unsaturated fatty acids. Accordingly, the unsaturated fatty acid may be present in the fatty acid component in an amount of about 10% or less by weight of the fatty acid component, including about 10% or less by weight, about 5% or less by weight, about 4% or less by weight, about 3% or less by weight, about 2% or less by weight, about 1% or less by weight, about 0.5% or less by weight, about 0% by weight, or any value or range between any two of these values.

In various embodiments, at least a portion of the fatty acid component may be contained. In some embodiments, the fatty acid may be pre-contained prior to adding 110 the fatty acid to the mineral salts. In other embodiments, the fatty acid may be contained as a result of the various processes 105, 110, 115, 120 described herein. In some embodiments, the fatty acid may generally be contained by at least one supermolecular structure. Supermolecular structures may include vesicular structures such as microemulsions, liposomes (vesicles), micelles, and reverse micelles. The liposomes (vesicles) may contain an aqueous volume that is entirely enclosed by a membrane composed of lipid molecules, such as phospholipids. In some embodiments, the liposomes may have a bilayer membrane. In some embodiments, the liposomes may include at least one surfactant. Examples of surfactants may include polyoxyethylene ethers and esters of fatty acids. The surfactant may have an hydrophilic-lipophilic balance (HLB) value of about 2 to about 12, including about 2, about 3, about 4, about 5, about 6, about 7, about 8, about 9, about 10, about 11, about 12, or any range or value between any two of these values. Micelles and reverse micelles are microscopic vesicles that contain amphipathic constituents but do not contain an aqueous volume that is entirely enclosed by a membrane. In micelles, the hydrophilic part of the amphipathic compound is on the outside (on the surface of the vesicle). In reverse micelles, the hydrophobic part of the amphipathic compound is on the outside. The reverse micelles may thus contain a polar core that can solubilize both water and macromolecules within the inverse micelle. As the volume of the core aqueous pool increases, the aqueous environment begins to match the physical and chemical characteristics of bulk water. The resulting inverse micelle may be referred to as a microemulsion of water in oil.

In some embodiments, at least a portion of the fatty acid may be contained in a core of a micelle or a vesicle. The core may include any number of particles therein in addition to the fatty acid. The core composition may be made of a core material that includes at least one of the protein material, the cellulosic material, the amino acid, and the amino acid derivative, as described in greater detail herein.

In various embodiments, at least a portion of the fatty acid component may be encapsulated. In some embodiments, the fatty acid may be pre-encapsulated prior to adding 110 the fatty acid to the mineral salts. In other embodiments, the fatty acid may be encapsulated as a result of the various processes 105, 110, 115, 120 described herein. In some embodiments, the fatty acid may generally be encapsulated by a capsule. The capsule may include a capsule shell, which is made up of at least one polysaccharide. Illustrative examples of capsule shells as described herein may include capsule shells including agar, gelatin, starch casein, chitosan, soya bean protein, safflower protein, alginates, gellan gum, carrageenan, xanthan gum, phthalated gelatin, succinated gelatin, cellulosephthalate-acetate, polyvinylacetate, hydroxypropyl methylcellulose, polyvinylacetate-phthalate, polymerisates of acrylic esters, polymerisates of methacrylic esters, and/or mixtures thereof.

In various embodiments, one or more other ingredients may be added 115 to the mineral lick mixture. The other ingredients may be added 115 at substantially the same time as processes 105 and 110, may be added subsequent to processes 105 and 110, may be added prior to processes 105 and 110, or may be added during process 120, as described in greater detail herein. Illustrative examples of other ingredients that may be added 115 include an emulsifier, a glucogenic precursor, an antioxidant, a vitamin, a trace element, carnitine, an amino acid, an amino acid derivative, a protein, a carbohydrate, a cellulosic material, a binding agent, a bulking agent, a filler, a flavoring agent, and the like, or a combination thereof, as described in greater detail herein. The other ingredients may include various portions generally included in particular amounts that are sufficient to provide beneficial nutritional and dietary needs of the ruminant that is to consume the mineral lick composition. For example, the mineral lick mixture may include a carbohydrate portion and a vitamin portion, each in an amount sufficient to provide beneficial nutritional and dietary needs of the ruminant.

The carbohydrate is not limited by this disclosure and may include any carbohydrates or combination of carbohydrates, particularly those used in animal feed and mineral lick compositions. In some embodiments, the carbohydrate may generally provide a source of energy for the mineral lick composition. Illustrative examples of carbohydrates may include molasses, sugar beet pulp, sugarcane, wheat bran, oat hulls, grain hulls, soybean hulls, peanut hulls, wood, brewery byproducts, beverage industry byproducts, forages, roughages, silages, molasses, sugars, starches, cellulose, hemicellulose, wheat, corn, oats, sorghum, millet, barley, barley fiber, barley hulls, barley middlings, barley bran, malting barley screenings, malting parley and fines, malt rootlets, maize bran, maize middlings, maize cobs, maize screenings, maize fiber, millet, rice, rice bran, rice middlings, rye, triticale, brewers grain, coffee grinds, tea leaf fines, citrus fruit pulp, rind residues, algae, algae meal, microalgae, and/or the like.

In various embodiments, the glucogenic precursor may include at least one of glycerol, propylene glycol, molasses, propionate, glycerine, propane diol, calcium propionate, propionic acid, octanoic acid, steam-exploded sawdust, steam-exploded wood chips, steam-exploded wheat straw, algae, algae meal, microalgae, or combinations thereof. The glucogenic precursor may generally be included in the mineral lick mixture to provide an energy source to the ruminant so as to prevent gluconeogenesis from occurring within the ruminant's body.

The antioxidant is not limited by this disclosure and may include any antioxidants or combination of antioxidants, particularly those used in animal feed and mineral lick compositions. Illustrative examples of antioxidants may include alpha-carotene. beta-carotene, ethoxyquin, butylated hydroxyanisole (BHA), butylated hydroxytoluene (BHT), cryptoxanthin, lutein, lycopene, zeaxanthin, vitamin A, vitamin C, vitamin E, selenium, alpha-lipoic acid, and/or the like.

In various embodiments, the vitamin may include any combination of vitamin A, vitamin B, vitamin C, vitamin D, vitamin E, vitamin K, and/or the like. Specific examples of vitamin B include thiamine (vitamin B₁), riboflavin (vitamin B₂), niacin (vitamin B₃), pantothenic acid (vitamin B₅), pyridoxine (vitamin B₆), biotin (vitamin B₇), folic acid (vitamin B₉), cobalamin (vitamin B₁₂), and choline (vitamin Bₚ).

In some embodiments, the mineral lick mixture may include an amount of carnitine. The carnitine may be included in the mineral lick mixture to aid in the breakdown of fatty acids to generate metabolic energy in the ruminant. In some embodiments, the carnitine may be present in a premix composition.

In some embodiments, the amino acid may be an essential amino acid, including any combination of leucine, lysine, histidine, valine, arginine, threonine, isoleucine, phenylalanine, methionine, tryptophan, and/or any derivative thereof. In some embodiments, the amino acid may be a non-essential amino acid, including any combination of alanine, asparagine, aspartate, cysteine, glutamate, glutamine, glycine, proline, serine, tyrosine, and/or any derivative thereof. The amino acid and/or any derivative thereof may also include amino acids and derivatives of both non-essential and essential amino acids. The amino acid may generally be included in the mineral lick mixture to provide a nutritional aid in various physiological processes in the ruminant, such as, for example, increasing muscle mass, providing energy, aiding in recovery, and/or the like. In some embodiments, the amino acid may be obtained from a premix composition.

In some embodiments, the protein may be obtained from a protein source. Illustrative examples of protein sources may include one or more grains and/or oilseed meals. The grain is generally not limited by this disclosure and may be any edible grain, or combination of grains, that is used as a protein source. Illustrative examples of grains include cereal grains such as barley, wheat, spelt wheat, rye, oats, triticale, rice, corn, buck wheat, quinoa, amaranthus, sorghum, and the like. Oilseed meal is generally derived from residue that remains after reserved oil is removed from oilseeds. The oilseed meal may be rich in protein and variable in residual fats and oils. Illustrative examples of oilseed meal includes rapeseed meal, soybean meal, sunflower meal, cottonseed meal, camelina meal, mustard seed meal, crambe seed meal, safflower meal, rice meal, peanut meal, corn gluten meal, corn gluten feed, distillers dried grains, distillers dried grains with solubles, wheat gluten, and/or the like.

In some embodiments, the mineral lick mixture may include at least one cellulosic material. The cellulosic material may generally provide a source of fiber for the ruminant to lower cholesterol levels and promote proper digestive function. Illustrative examples of cellulosic materials include wheat bran, wheat middlings, wheat mill run, oat hulls, oat bran, soya hulls, grass meal, hay meal, alfalfa meal, alfalfa, straw, hay, algae, algae meal, microalgae, and/or the like. In some embodiments, the mineral lick composition may be coated on a cellulosic carrier, as described in greater detail herein. Examples of suitable cellulosic carriers for use in mineral lick coatings may include straw, hay, grass, and grain.

In various embodiments, the mineral lick mixture may include a micronutrient mixture. Micronutrient mixtures are not limited by this disclosure and may generally contain any micronutrient mixture now known or later developed. The micronutrient mixture may include various components, such as at least one vitamin and at least one mineral, as described in greater detail herein. In some embodiments, the micronutrient mixture may be obtained from a premix composition.

The binding agent may provide adhesive properties to the mineral lick mixture, particularly so that the mineral lick mixture does not fall apart in when formed into a mineral lick composition, as described in greater detail herein. Examples of binding agents include polysaccharides, proteins, and the like, or a combination thereof. The bulking agent may generally increase the bulk of the mineral lick composition without affecting the taste of the mineral lick composition. Examples of bulking agents may include silicate, kaolin, clay, and/or the like. The filler may generally be used to increase bulk, weight, viscosity, opacity, strength, and/or the like. Examples of filler may include gluten feed, sunflower hulls, distillers grains, guar hulls, wheat middlings, rice hulls, rice bran, oilseed meals, dried blood meal, animal byproduct meal, fish byproduct meal, dried fish solubles, feather meal, poultry byproducts, meat meal, bone meal, dried whey, soy protein concentrate, soy flour, yeast, wheat, oats, grain sorghum, corn feed meal, rye, corn, barley, aspirated grain fractions, brewers dried grains, corn flower, corn gluten meal, feeding oat meal, sorghum grain flour, wheat mill run, wheat red dog, hominy feed, wheat flower, wheat bran, wheat germ meal, oat groats, rye middlings, cotyledon fiber, and/or ground grains.

In various embodiments, the mineral lick mixture may be formed 120 to obtain the mineral lick composition. In some embodiments, forming 120 may include forming the mineral lick mixture into a solid block, a molded block, a non-liquid form, semi-solid forms, an agglomeration, a conglomeration, and/or the like. As used herein, “solid” is used to distinguish from liquid or semi-solid forms, and is meant to capture hollow structures having solid sidewalls, or solid material that may otherwise be provided with some voids, such as for reducing weight, mounting, or securing purposes. Accordingly, forming 120 may include pressing, molding, extruding, grinding, pelleting, encapsulating, granulating and/or the like. Pressing may include, for example, applying a pressure to an amount of the mineral lick composition. Molding may include, for example, open molding, compression molding, injection molding, centrifugal molding, or the like. Extruding may include, for example, forming an amount of the mineral lick composition by forcing the mineral lick composition through a die having a desired shape and size.

Grinding may be performed by various grinding devices known to those having ordinary skill in the art, such as a hammer mill, a roller mill, a disk mill, or the like. The mineral lick mixture and/or portions thereof may be ground to various sizes, such as particle size (for instance, measured in millimeters), mesh sizes, surface areas, or the like. According to some embodiments, the mineral lick mixture and/or portions thereof may be ground to an average particle size of about 0.05 mm to about 10 mm. More particularly, the mineral lick mixture may be ground to produce a granular material having an average particle size of about 0.05 mm, about 0.1 mm, about 0.2 mm, about 0.5 mm, about 1.0 mm, about 2.0 mm, about 3.0 mm, about 4.0 mm, about 5.0 mm, about 6.0 mm, about 7.0 mm, about 8.0 mm, about 9.0 mm, about 10.0 mm, or any value or range between any two of these values. In some embodiments, the mineral lick mixture may be ground so that about 20% to 50% of the ground mineral lick mixture is retained by a mesh having openings with a size of about 10 mm and so that about 70% to about 90% of the ground mineral lick mixture is retained by a mesh having openings with a size of about 1 mm. In some embodiments, the mineral lick compositions and/or various portions thereof may have a varying distribution of particle sizes based upon the ingredients. For example, in embodiments containing one or more wheat ingredients, the particle size may be distributed so that about 95% of the ground wheat ingredients are retained by a mesh having openings with a size of about 0.0625 mm and so that about 65% of the ground wheat ingredients are retained by a mesh having openings with a size of about 1.0 mm. In another example, such as embodiments containing one or more barley ingredients, the particle size may be distributed so that about 95% of the ground barley ingredients are retained by a mesh having openings with a size of about 0.0625 mm and so that about 60% of the ground barley ingredients are retained by a mesh having openings with a size of about 1.0 mm. The varying mesh sizes of each ingredient may be independent of mesh sizes for other ingredients.

Grinding may provide various benefits, such as improving certain characteristics of the mineral lick mixture and/or the mineral lick composition formed therefrom. For instance, even and fine particle size may improve the mixing of different ingredients. According to certain embodiments, grinding may be configured to decrease a particle size of certain components of the mineral lick composition, for example, to increase the surface area open for enzymes in the gastrointestinal tract, which may improve the digestibility of nutrients, and/or to increase the palatability of the feed.

In some embodiments, a binding agent, a bulking agent, a filler, and/or the like may be added to granular material to form 120 the mineral lick composition into a desired shape.

In various embodiments, forming 120 may include heating the mineral lick mixture. In some embodiments, the mineral lick mixture may be heated to a temperature above a melting point of the saturated fatty acid to form a heated mineral lick mixture, as described in greater detail herein. In some embodiments, forming 120 may include coating a cellulosic carrier with the mineral lick mixture to form a coated cellulosic carrier, as described in greater detail herein. In some embodiments, forming 120 may include cooling the coated cellulosic carrier. Cooling may be done by any method of cooling, and may generally be completed to ensure the mineral lick mixture hardens into the mineral lick composition around the cellulosic carrier. In particular embodiments, the mineral lick mixture may be formed 120 around a rope, a tree trunk, a post, grass, straw, hay, grain, feed material, and/or the like.

In various embodiments, forming 120 may include heating the mineral lick mixture to a temperature above a melting point of the saturated fatty acid, as described in greater detail herein. Forming 120 may further include adding a fluid to the heated mineral lick mixture. The fluid is not limited by this disclosure, and may generally contain any fluid suitable for forming a salt hydrate crystalline structure from the mineral lick mixture. Illustrative examples of a fluid may include water or a substantially aqueous solution. Forming 120 may also include placing the salt hydrate crystalline structure into a mold. The mold may have a shape and/or a size that is based upon a desired shape and/or size of a resultant mineral lick composition.

In various embodiments, forming 120 may include drying the mineral lick composition. Drying may generally be completed to remove any excess water or other undesired materials.

In various embodiments, an emulsifier may be combined 205 with the mineral lick mixture to form an emulsion, as depicted in FIG. 2. In some embodiments, the emulsion may include, for example, water, sodium palmitate, and palmitate. The combination 205 may include combining the mineral lick mixture and the emulsifier under pressure. In some embodiments, the pressure may be about 1 atm to about 10 atm. In particular embodiments, the pressure may be about 1 atm, about 2 atm, about 3 atm, about 4 atm, about 5 atm, about 6 atm, about 7 atm, about 8 atm, about 9 atm, about 10 atm, or any value or range between any two of these values. The emulsion may be added 210 with the other ingredients and the resulting product may be formed 220, as described in greater detail herein, to obtain the final product.

The emulsifier is not limited by this disclosure, and may generally be any composition that is capable of emulsifying and/or pelletizing the mineral lick composition. In some embodiments, the emulsifier may be a nonionic emulsifier. Specific examples of nonionic emulsifiers may include ethoxylated fatty alcohols, ethoxylated alkylphenols, ethoxylated fatty acids, sorbitan derivatives, sucrose esters and derivatives, ethylene oxide-propylene oxide block copolymers, fluorinated alkyl polyoxyethylene ethanols, and/or any combination thereof. Other examples of emulsifiers may include lecithin, natural seed weed, natural seed gums, natural plant exudates, natural fruit extracts, animal skin and bone extracts, bio-synthetic gums, starches, fibers, sucrose esters, Tween, polyglycerol esters, sugar esters, castor oil, and ethoxylated castor oil, an ammonia solution, butoxyethanol, propylene glycol, ethylene glycol, ethylene glycol polymers, polyethylene, methoxypolyethylene glycol, and/or any combination thereof. Examples of natural seed weed may include carrageenan, alginates, agar, agarose, fucellan, and xanthan gum or a combination thereof. Examples of natural seed gums may include guar gum, locust bean gum, tara gum, tamarind gum, and psillium gum. Examples of natural plant exudates are gum Arabic, tragacanth, karaya, and ghatti. Natural fruit extracts are, for example, low and high methoxyl pectins. Animal skin and bone extracts are, for example, gelatin A, gelatin B, and hydrolyzed gelatin. Gum Arabic is a natural food additive obtained from certain varieties of acacia. It is generally tasteless and odorless, and may be used in commercial food processing to thicken, emulsify, and/or stabilize foods. Guar gum is a gummy substance obtained from plants of the legume genera. Guar gum may also be used as a thickener and/or a stabilizer in commercial food processing. Xanthan gum is produced by fermentation of corn sugar, and may be used as a thickener, an emulsifier, and/or a stabilizer of foods. In particular embodiments, gum Arabic, guar gum, xanthan gum, and/or pectin may be used in combination as an emulsion stabilizer. Illustrative examples of bio-synthetic gums may include xanthan, gellan, curdian, and pullulan. Examples of starches may include natural starch, chemically modified starch, physically modified starch, and enzymatically modified starch. Castor oil may be effective as an emulsifier because of its ability to render oil soluble in water.

In various embodiments, the emulsifier may have a hydrophilic-lipophilic balance HLB of about 5 to about 14. In particular embodiments, the HLB of the emulsifier may be about 5, about 6, about 7, about 8, about 9, about 10, about 11, about 12, about 13, about 14, or any value or range between any two of these values.

In various embodiments, the emulsifier may be present in the mineral lick composition in an amount of about 0.01% by weight to about 2.0% by weight of the mineral lick composition. In particular embodiments, the emulsifier may be present in the mineral lick composition in an amount of about 0.01% by weight, about 0.05% by weight, about 0.1% by weight, about 0.2% by weight, about 0.25% by weight, about 0.3% by weight, about 0.5% by weight, about 0.6% by weight, about 0.75% by weight, about 1.0% by weight, about 1.25% by weight, about 1.5% by weight, about 1.75% by weight, about 2.0% by weight, or any value or range between any two of these values.

In various embodiments, a method of increasing milk fat content in ruminants may include providing the mineral lick composition as described herein to the ruminant for ingestion. In particular embodiments, the mineral lick composition may be a solid mineral lick composition, as described in greater detail herein. In some embodiments, the mineral lick composition may be provided as a supplement or a booster. In some embodiments, the composition may be coated on a material to be provided to the ruminant. In some embodiments, the mineral lick composition may be provided to the ruminant in an amount that the ruminant receives at least about 10 grams of fatty acid per kilogram of milk produced by the ruminant each day. The amount may be based on the previous day's milk production by the ruminant, an average day based on the previous week's milk production by the ruminant, an average day based on the previous month's milk production by the ruminant, an average production of milk by the ruminant when not provided the mineral lick composition, and/or the like. In some embodiments, the ruminant may be provided with additional amounts of the mineral lick composition to make up for portions of the mineral lick composition that are not consumed by the ruminant such as amounts that are spilled by the ruminant when consuming the mineral lick composition, amounts that are consumed by other animals, amounts that are ruined or spoiled, and/or the like.

In some embodiments, providing the mineral lick composition to the ruminant for the ruminant to consume may result in an increase in production of milk and/or an increase in fat content of the milk produced. These increases may generally be relative to a similar ruminant that does not receive the mineral lick composition, an average of similar ruminants not receiving the mineral lick composition, an average of the milk production quantity and fat content of the same ruminant when not provided the mineral lick composition, and/or the like. In particular embodiments, the milk production may increase by an amount of about 1% to about 10%, including about 1%, about 2%, about 3%, about 4%, about 5%, about 6%, about 7%, about 8%, about 9%, about 10%, or any value or range between any two of these values. In particular embodiments, the milk fat content may increase by an amount of about 10% to about 15%, including about 10%, about 11%, about 12%, about 13%, about 14%, about 15%, or any value or range between any two of these values.

### EXAMPLES

### Example 1

### Making a Mineral Lick Composition

A mineral lick composition to be used as a nutritional supplement is made for coating on a rope. The mineral lick composition includes about 48% by weight of a fatty acid component. The fatty acid component is substantially 100% palmitic acid, thereby containing no unsaturated trans fatty acids. The mineral lick composition also includes about 48% by weight of a plurality of mineral salts. The mineral salts include sodium acetate, sodium chloride, sodium bicarbonate, calcium carbonate, calcium chloride, and magnesium oxide. About 2% by weight of binder material is also present to ensure that the mineral lick composition will stick to the rope.

The mineral lick composition may be made by combining the fatty acid component with the plurality of mineral salts and the binder material in a mixer to obtain a mineral lick mixture. The mineral lick mixture is then be transferred to a pot and heated to about 60° C. so that the fatty acid component melts and the mixture is in a substantially liquid form. The mixture is transferred to a sprayer, which is used to spray the mixture over the entire surface of a piece of rope that can be hung in a dairy cow's stall for licking.

### Example 2

### Feeding a Dairy Cow

A dairy cow that has a normal (untreated) average daily production of 28 kg milk is provided with the mineral lick composition described above with respect to Example 1 to increase the milk fat and the quantity of the milk produced.

The dairy cow is given about 500 grams of the mineral lick composition by hanging the rope in the cow's stall for the cow to consume ad libitum. This amount is selected to ensure that the cow consumes at least about 280 grams of the mineral lick composition, based upon an average amount of time the cow consumes salt licks over the course of a day. This amount corresponds to about 10 grams of palmitic acid for every kilogram of milk that she will produce that day. As a result, she is expected to produce 10% more milk than she did previously and the milk that she produces contains 15% more milk fat content than the milk she produced previously.

### Example 3

### Providing to a Large Group of Cows

The mineral lick composition as described above with respect to Example 1 is provided to a large group of cows on a commercial dairy farm to confirm its effectiveness. A group of 500 dairy cows from the commercial dairy farm is selected at random to provide a wide variety of variation in various characteristics, such as breed, weight, age of the cow, and the like. The 500 cows are equally divided into two groups: a sample cow group and a control cow group. Each day, the sample cow group is given, ad libitum, a mineral lick composition on a rope. The control group does not receive the mineral lick composition. The 500 cows are monitored for the amount of mineral lick composition consumed, changes in weight, an amount of milk the cow produces each day, and the composition of the milk produced by the cow each day. Monitoring continues for a period of 60 days. A comparison of the two groups of cows over this period of time shows a statistically significant improvement from the group that consumed the solid booster over the control group that did not receive the solid booster.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A mineral lick composition for ruminants, the mineral lick composition comprising:
at least one sodium salt;
at least one calcium salt;
at least one magnesium salt; and
at least one fatty acid component comprising at least about 80% saturated fatty acid by weight.

2. The mineral lick composition of claim 1, wherein the saturated fatty acid comprises at least one palmitic acid compound.

3. The mineral lick composition of claim 1, wherein the saturated fatty acid comprises at least one palmitic acid compound comprising free palmitic acid or a palmitic acid derivative selected from the group consisting of a palmitic acid ester, a palmitic acid amide, a palmitic acid salt, a palmitic acid carbonate, a palmitic acid carbamates, a palmitic acid imide and a palmitic acid anhydride.

4. The mineral lick composition of claim 1, wherein the saturated fatty acid comprises a palmitic acid compound in an amount of at least about 60% by weight of the saturated fatty acid.

5.-8. (canceled)

9. The mineral lick composition of claim 1, further comprising at least one emulsifier capable of emulsifying and pelletizing the mineral lick composition.

10. (canceled)

11. The mineral lick composition of claim 9, wherein the emulsifier comprises castor oil.

12. (canceled)

13. The mineral lick composition of claim 9, wherein the emulsifier is present in the mineral lick composition in an amount of about 0.01% by weight to about 1.0% by weight of the mineral lick composition.

14.-16. (canceled)

17. The mineral lick composition of claim 1, further comprising at least one glucogenic precursor selected from the group consisting of glycerol, propylene glycol, molasses, propionate, glycerine, propane diol, and calcium propionate.

18. The mineral lick composition of claim 1, further comprising at least one vitamin comprising vitamin A, vitamin B vitamin C, vitamin D, vitamin E, or vitamin K.

19. (canceled)

20. The mineral lick composition of claim 1, further comprising carnitine.

21. The mineral lick composition of claim 1, further comprising an amino acid selected from the group consisting of leucine, lysine, histidine, valine, arginine, threonine, isoleucine, phenylalanine, methionine, tryptophan, and any derivative thereof.

22. The mineral lick composition of claim 1, wherein the at least one sodium salt is selected from the group consisting of monosodium phosphate, sodium acetate, sodium chloride, sodium bicarbonate, disodium phosphate, sodium iodate, sodium iodide, sodium tripolyphosphate, sodium sulfate, and sodium selenite.

23. The mineral lick composition of claim 1, wherein the at least one calcium salt is selected from the group consisting of calcium acetate, calcium carbonate, calcium chloride, calcium gluconate, calcium hydroxide, calcium iodate, calcium iodobehenate, calcium oxide, anhydrous calcium sulfate, calcium sulfate dehydrate, dicalcium phosphate, monocalcium phosphate, and tricalcium phosphate.

24. The mineral lick composition of claim 1, wherein the at least one magnesium salt is selected from the group consisting of magnesium acetate, magnesium carbonate, magnesium oxide, and magnesium sulfate.

25. The mineral lick composition of claim 1, further comprising a mineral composition comprising at least one mineral selected from the group consisting of potassium, phosphorus, zinc, sulfur, selenium, manganese, iron, cobalt, copper, iodine, and molybdenum.

26. (canceled)

27. The mineral lick composition of claim 1, further comprising at least one additional salt selected from the group consisting of a manganese salt, a zinc salt, an iron salt, a potassium salt, and a manganese salt.

28.-30. (canceled)

31. The mineral lick composition of claim 1, further comprising at least one of copper sulfate, copper oxide, selenium yeast and a chelated mineral.

32. The mineral lick composition of claim 1, further comprising at least one protein material selected from the group consisting of a grain and an oilseed meal.

33.-38. (canceled)

39. The mineral lick composition of claim 1, wherein the at least one sodium salt comprises about 5% by weight to about 15% by weight of the mineral lick composition.

40. The mineral lick composition of claim 1, wherein the at least one calcium salt and the at least one magnesium salt are each present in the mineral lick composition in an amount of about 5% by weight to about 25% by weight.

41.-42. (canceled)

43. A method of preparing a mineral lick composition for ruminants, the method comprising:
combining at least one sodium salt, at least one calcium salt, at least one magnesium salt, and at least one saturated fatty acid component to provide a mineral lick mixture; and
forming the mineral lick composition from the mineral lick mixture.

44. The method of claim 43, wherein the saturated fatty acid is a palmitic acid compound.

45. The method of claim 44, wherein the palmitic acid compound comprises free palmitic acid or a palmitic acid derivative selected from a palmitic acid ester, a palmitic acid amide, a palmitic acid salt, a palmitic acid carbonate, a palmitic acid carbamates, a palmitic acid imide, a palmitic acid anhydride, or a combination thereof.

46. (canceled)

47. The method of claim 43, wherein the combining further comprises adding at least one emulsifier to the mineral lick mixture under pressurization to provide an emulsion.

48.-49. (canceled)

50. The method of claim 43, wherein the combining further comprises adding at least one additive to the mineral lick mixture, the at least one additive being selected from the group consisting of a glucogenic precursor, a vitamin, carnitine, an amino acid, a mineral and a protein.

51.-58. (canceled)

59. The method of claim 43, wherein the forming comprises:
heating the mineral lick mixture to a temperature above a melting point of the saturated fatty acid component to form a heated mineral lick mixture;
coating a cellulosic carrier with the heated mineral lick mixture to form a coated cellulosic carrier; and
cooling the coated cellulosic carrier.

60. (canceled)

61. The method of claim 43, wherein the forming comprises:
heating the mineral lick mixture to a temperature above a melting point of the saturated fatty acid component;
adding a fluid to the heated mineral lick mixture to form a salt hydrate crystalline structure; and
placing the salt hydrate crystalline structure into a mold to obtain the formed mineral lick supplement.

62.-67. (canceled)

68. A mineral lick composition for ruminants, the mineral lick composition comprising:
a fatty acid component comprising palmitic acid in an amount of at least about 60% by weight of the fatty acid component;
at least one sodium salt;
at least one calcium salt; and
at least one magnesium salt,
wherein the fatty acid component comprises an unsaturated trans fatty acid content in an amount of about 5% or less by weight of the fatty acid component.

69. The mineral lick composition of claim 68, wherein the fatty acid component consists essentially of a palmitic acid compound.

70. The mineral lick composition of claim 68, wherein the fatty acid component consists of a palmitic acid compound.
